(19) United States
(12) Patent Application Publication
(10) Pub. No.: US 2016/0145374 A1
(43) Pub. Date: May 26, 2016

(54) POLYOL MIXTURE FOR PRODUCING RIGID POLYURETHANE FOAM

(71) Applicant: KAO CORPORATION, Tokyo (JP)

(72) Inventor: Atsushi ISHIKAWA, Wakayama-shi, Wakayama-ken (JP)

(73) Assignee: KAO CORPORATION, Tokyo (JP)

(21) Appl. No.: 14/904,332

(22) PCT Filed: Jul. 22, 2014
(86) PCT No.: PCT/JP2014/069328

§ 371 Date: Jan. 11, 2016

(30) Foreign Application Priority Data
Jul. 24, 2013 (JP) 2013-153226

(51) Int. Cl. C08G 18/42; C08G 18/50; C08J 9/14; C08G 18/20; C08G 18/08; C08J 9/00; C08G 18/76; C08G 18/48

(52) U.S. Cl. CPC C08G 18/4213; C08G 18/7664; C08G 18/5027; C08G 18/5024; C08G 18/48; C08G 18/2027; C08G 18/14; C08J 9/0038; C08J 9/0061; C08J 9/147; C08G 18/0838; C08G 2101/0025

(57) ABSTRACT

A polyol mixture for producing a rigid polyurethane foam, the polyol mixture containing (A) a polyol component having a hydroxyl value of 100 mgKOH/g or more and 550 mgKOH/g or less; (B) a blowing agent containing one or more hydrohaloolefin-based blowing agents selected from the group consisting of trans-1-chloro-3,3,3-trifluoro-1-propene (B1) and cis-1,1,1,4,4,4-hexafluoro-2-butene (B2); (C) a catalyst containing an imidazole-based catalyst (C1) represented by the formula (I); (D) an organic acid containing one or more members selected from the group consisting of succinic acid and glutaric acid; and (E) a foam stabilizer. The polyurethane foam obtained by using a polyol mixture of the present invention can be suitably used as insulation materials for construction materials, refrigerators, refrigerating/freezing warehouses, bath tubs, and pipes; dew stoppers for houses, apartment houses, industrial pipes, and the like.

### FIELD OF THE INVENTION

The present invention relates to a polyol mixture for producing a rigid polyurethane foam. More specifically, the present invention relates to a polyol mixture which can be suitably used in the production of a rigid polyurethane foam that can be suitably used as insulation materials for building materials, refrigerators, refrigerating/freezing warehouses, bath tubs, pipes, and the like; dew stoppers for houses, apartment houses, industrial piping, and the like, and a method for producing a rigid polyurethane foam using the polyol mixture.

### BACKGROUND OF THE INVENTION

Since rigid polyurethane foams (including polyisocyanurate foams containing an isocyanurate ring) have excellent heat insulation properties and flame retardant properties, the rigid polyurethane foams have been used as insulation materials for building materials, refrigerators, refrigerating/freezing warehouses, bath tubs, pipes, and the like.

When rigid polyurethane foams are used, for example, as an insulation material for houses, building construction materials, and the like, the rigid polyurethane foams are produced by a method including mixing a component containing a polyol as a main component and a component containing a polyisocyanate as a main component in the presence of a blowing agent, a catalyst, a foam stabilizer, and optionally other aids, and injecting the mixture into a mold to foam and cure; a method including spraying the mixture to an intended site on a wall surface, ceiling or the like in the construction sites, and allowing the mixture to blow and cure on the coated surface material; a method including blowing and curing and thereafter cutting out; and the like.

In the recent year, from the viewpoint of global environmental protection of avoiding destruction of ozone layer in the stratosphere, global warming or the like, as a blowing agent, hydrohaloolefins such as trans-1,3,3,3,-tetrafluoro-1-propene, 2,3,3,3,-tetrafluoro-1-propene, trans-1-chloro-3,3,3,-trifluoro-1-propene, and cis-1,1,1,4,4,4-hexafluoro-2-butene have been studied. While these blowing agents are fluorine-containing compounds, the coefficient of ozone destruction is substantially zero, and the coefficient of global warming is very small as 10 or less, so that the hydrohaloolefins are expected as substitutes for hydrofluorocarbons such as 1,1,1,3,3-pentafluoropropane and 1,1,1,3,3,-pentafluorobutane.

In addition, among the hydrohaloolefins, especially, production methods using trans-1,3,3,3,-tetrafluoro-1-propene or trans-1-chloro-3,3,3,-trifluoro-1-propene or the like as a blowing agent have been reported (see, Patent Publications 1 to 3). These publications describe the use of “a sterically hindered amine catalyst” or “a catalyst which is an adduct of an amine and an organic acid,” or a production method in which the degradation reaction is inhibited by not including a polar solvent (water), in order to inhibit the degradation of the blowing agent.

On the other hand, an acid block catalyst as a delayed catalyst is known as a urethane catalyst, and especially a mixture of a tertiary amine and a saturated dicarboxylic acid has been proposed for the purpose of inhibiting corrosion of facilities and the like (see, Patent Publication 4). In addition, a proposal has been made to improve the filling property in a mold by using a salt of an imidazole-based compound with an organic acid together with a salt of cycloamidine with an acid to inhibit an initial reaction of a water blowing composition (see, Patent Publication 5). The basic concepts in these publications are in common that delayed effects of reaction are intended by mixing an organic acid to an amine catalyst, in other words, carrying out an acid blocking.

Patent Publication 1: Japanese translation of PCT international Application Publication No. 2011-500892

Patent Publication 2: Japanese translation of PCT international Application Publication No. 2011-500893

Patent Publication 3: Japanese translation of PCT international Application Publication No. 2013-501844

Patent Publication 4: Japanese Unexamined Patent Application Publication No. 2000-95831

Patent Publication 5: Japanese Unexamined Patent Application Publication No. 2009-215448

### SUMMARY OF THE INVENTION

The present invention relates to the following [1] to [2]:

[1] A polyol mixture for producing a rigid polyurethane foam, the polyol mixture containing:
(A) a polyol component having a hydroxyl value of 100 mgKOH/g or more and 550 mgKOH/g or less;
(B) a blowing agent containing one or more hydrohaloolefin-based blowing agents selected from the group consisting of trans-1-chloro-3,3,3-trifluoro-1-propene (B1) and cis-1,1,1,4,4,4-hexafluoro-2-butene (B2);
(C) a catalyst containing an imidazole-based catalyst (C1) represented by the formula (I):

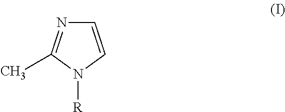

wherein R is a methyl group, an n-butyl group, or an isobutyl group;

(D) an organic acid containing one or more members selected from the group consisting of succinic acid and glutaric acid; and
(E) a foam stabilizer.
[2] A method for producing a rigid polyurethane foam including the step of mixing a polyol mixture as defined in the above [1] and a polyisocyanate component, to allow foaming and curing reaction.

### DETAILED DESCRIPTION OF THE INVENTION

Rigid polyurethane foams are widely usable in applications that require excellent heat insulation property for building materials and the like. The heat conductivity of a blowing agent gas is greatly attributable to the heat insulation performance of the rigid polyurethane foams, and the hydrohaloolefin is said to be a very beneficial blowing agent from the viewpoint of the above-mentioned global environmental protection, in addition to low heat conductivity.

However, the hydrohaloolefin causes a partial degradation when contacted with a tertiary amine, which is a urethane catalyst, so that there are some disadvantages that not only turbidity of the polyol mixture is caused, but also the tertiary amine is partially deactivated, to lower its reactivity.

Even in a case where sterically hindered amine catalyst shown in the above patent publications, in other words, a tertiary amine introduced with a bulky N-substituent (a cyclohexyl group, an ethyl group, a propyl group, a benzyl group, etc.), or an N-substituted, nitrogen-containing heterocyclic compound (morpholine-based, imidazole-based, piperazine-based and other compounds) is used as a urethane catalyst, catalysts having high activity are caused to have turbidity in a long-term storage, and catalysts that are less likely to cause turbidity in the polyol mixture have low activities and have extremely delayed initial reactions (reactivity cannot be secured even if blended in large amounts), thereby making them unsatisfactory, and the problems have not yet been solved.

In addition, even though acid block catalysts composed of a tertiary amine and an organic acid have some effects of inhibiting the degradation of a blowing agent by moderating a degree of alkalinity of the tertiary amine, the acid block catalysts act as delayed catalysts, and the reactivities at the designing stage of the polyol mixtures are low, so that there are some disadvantage that rigid polyurethane foams cannot be produced rapidly even when the polyol mixture is mixed with a polyisocyanate component.

The present invention relates to a polyol mixture for a rigid polyurethane foam hardly having any degradation for reactivities and external appearance of the polyol mixture with the days passed, especially excellent reactivity at an initial stage, even when a hydrohaloolefin having excellent environmental protection property is used as a blowing agent.

The present invention also relates to a method for producing a rigid polyurethane foam that can be rapidly produced by mixing a polyol mixture mentioned above and a polyisocyanate component.

According to the polyol mixture of the present invention, even when a hydrohaloolefin is used as a blowing agent, effects are exhibited that the polyol mixture has hardly any degradation for reactivities and external appearance of the polyol mixture with the days passed, in other words, excellent storage stability, whereby making it possible to stably produce a rigid polyurethane foam. In addition, according to the method for producing a rigid polyurethane foam of the present invention, some effects are exhibited that the polyol mixture is excellent in reactivity at an initial stage, so that the liquid drips do not take place even when sprayed to intended sites such as the wall surfaces or ceilings at the construction sites, whereby the rigid polyurethane foam can be rapidly produced.

The present invention is based on the findings that in a polyol mixture containing a hydrohaloolefin and an amine catalyst, an imidazole-based catalyst having a particular structure is used as an amine catalyst, and the polyol mixture further contains a specified organic acid, so that the storage stability of the polyol mixture obtained is remarkably improved, and that the reactivity of the imidazole-based catalyst which is said to have a low reactivity at an initial stage is also improved, whereby a rigid polyurethane foam produced from the above can be rapidly produced.

The polyol mixture of the present invention is excellent in storage stability and reactivity. Although the reasons why especially remarkable effects as mentioned above are exhibited are not elucidated, they are assumed to be as follows. A hydrohaloolefin such as trans-1-chloro-3,3,3-trifluoro-1-propene has a structure including a halogen atom and an unsaturated bond, so that its stability for an alkali component (tertiary amine) is worsened, and the hydrohaloolefin undergoes degradation to form a tertiary amine salt between the halogen atom and the alkali component, whereby the tertiary amine component is reduced along with the degradation of the hydrohaloolefin to lower the reactivity, and the degradation product of the hydrohaloolefin or the tertiary amine salt is precipitated which is assumed to form turbidity. However, it is assumed that the imidazole-based catalyst has a smaller pKa value and weaker basicity than the other tertiary amines, so that the catalyst inhibits the degradation of the hydrohaloolefin, and the organic acid also functions towards the neutralization of the tertiary amine, thereby inhibiting the degradation. Here, the above are assumptions, and the present invention is not limited to the above mechanisms. Also, the detailed reasons why the reactivity is improved are not clarified, it is observed that the reaction is accelerated only when specified organic acids (succinic acid and glutaric acid) are present in the polyol mixture of the present invention, and the present invention is perfected thereby.

<Polyol Mixture>

The polyol mixture of the present invention contains:

(A) a polyol component having a hydroxyl value of 100 mgKOH/g or more and 550 mgKOH/g or less;
(B) a blowing agent containing one or more hydrohaloolefin-based blowing agents selected from the group consisting of trans-1-chloro-3,3,3-trifluoro-1-propene (hereinafter also referred to as “TCTFP”) (B1) and cis-1,1,1,4,4,4-hexafluoro-2-butene (hereinafter also referred to as “CHFB”) (B2);
(C) a catalyst containing an imidazole-based catalyst (C1) represented by the formula (I):

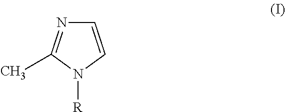

wherein R is a methyl group, an n-butyl group, or an isobutyl group;

(D) an organic acid containing one or more members selected from the group consisting of succinic acid and glutaric acid; and
(E) a foam stabilizer.

1. Component (A)

The polyol component (A) in the present invention has a hydroxyl value (units: [mgKOH/g]) of 100 or more and 550 or less. The above hydroxyl value is 100 or more, preferably 150 or more, and more preferably 200 or more, from the viewpoint of giving the rigid polyurethane foam strength, and the hydroxyl value is 550 or less, preferably 500 or less, and more preferably 480 or less, from the same viewpoint. Here, in a case of where the polyol constituting the component (A) is a single kind, the hydroxyl value of the component (A) means its hydroxyl value. In a case where the polyols constituting the component (A) are two or more kinds, the hydroxyl value means a weighted-average hydroxyl value, and if the weighted average hydroxyl value falls within the above range, a polyol not having the above hydroxyl value may be included. Here, the hydroxyl value as referred to herein is a value obtained based on JIS K1557.

Examples of the polyol include those that are conventionally usable when the rigid polyurethane foams are produced. Representative examples of the polyol include, for example, polyester-polyols, polyether-polyols, polymer-polyols, phenol resin-based polyols, mannich-polyols, and the like, which are described in “Polyurethane Resin Handbook,” edited by Keiji Iwata (Sep. 25, 1987, published by NIKKAN KOGYO SHIMBUN, LTD.). These polyols can be used alone or in a mixture of two or more kinds.

The polyester-polyols include aromatic polyester-polyols and aliphatic polyester-polyols. These polyester-polyols can be produced by a condensation reaction between a polybasic acid and a polyhydric alcohol, and aromatic polybasic acids are used in the aromatic polyester-polyols, and aliphatic polybasic acids are used in the aliphatic polyester-polyols.

The polybasic acid includes, for example, linear saturated aliphatic dicarboxylic acids such as glutaric acid, adipic acid, pimelic acid, suberic acid, azelaic acid, and sebacic acid; cyclic saturated aliphatic dicarboxylic acids such as cyclohexanedicarboxylic acid; aromatic dicarboxylic acids such as phthalic acid, terephthalic acid, and isophthalic acid; unsaturated aliphatic dicarboxylic acids such as maleic acid, fumaric acid, itaconic acid, and citraconic acid; halogen-containing aromatic dicarboxylic acids such as tetrabromophthalic acid; ester formable derivatives thereof; and acid anhydrides thereof, and the like. These polybasic acids can be used alone or in a combination of two or more kinds. The polybasic acid may contain a trifunctional or higher polyfunctional polybasic acid such as trimellitic acid or pyromellitic acid as desired, in addition to the dicarboxylic acid and derivatives thereof mentioned above.

The polyhydric alcohol includes, for example, ethylene glycol, diethylene glycol, triethylene glycol, propylene glycol, dipropylene glycol, 1,4-butanediol, 1,5-pentanediol, 3-methyl-1,5-pentanediol, 1,6-hexanediol, trimethylolpropane, glycerol, pentaerythritol, diglycerol, dextrose, sorbitol, and the like. These polyhydric alcohols can be used alone or in a combinations of two or more kinds.

As the polyester-polyol, a phthalic acid-based polyester-polyol produced by a condensation reaction between an aromatic dicarboxylic acid containing one or more members selected from phthalic acid, terephthalic acid, and isophthalic acid as a main component and a polyhydric alcohol containing one or more members selected from ethylene glycol, diethylene glycol, triethylene glycol, and tetraethylene glycol as a main component is preferred. Here, the phthalic acid-based polyester-polyol can also be produced using a polyethylene terephthalate recycled from used PET manufactured article as a raw material, and subjecting the polyethylene terephthalate to glycolysis degradation with a polyhydric alcohol such as ethylene glycol or diethylene glycol, and can be suitably used.

The polyether-polyol includes polyoxyalkylene-based polyols.

The polyoxyalkylene-based polyol can be produced by using compounds having two or more functional groups which are selected from a hydroxyl group, a primary amino group, a secondary amino group, and other active hydrogen-containing group as starting raw materials, and subjecting an alkylene oxide to a ring-opening addition reaction. For example, the polyoxyalkylene-based polyol can be produced by subjecting a polyvalent amine, a polyhydric alcohol, an alkanolamine, a polyhydric phenol or the like to an addition reaction with an alkylene oxide. Here, the two or more functional groups mentioned above may be identical or different.

Examples of the polyvalent amine include ethylenediamine, tolylenediamine, diethyltoluenediamine, diethylenetriamine, triethylenepentamine, and the like. Examples of the polyhydric alcohol include ethylene glycol, diethylene glycol, propylene glycol, dipropylene glycol, glycerol, pentaerythritol, diglycerol, sugars, sucrose, dextrose, sorbitol, and the like. Examples of the alkanolamine include ethanolamine, diethanolamine, triethanolamine, methyldiethanolamine, and the like. Examples of the polyhydric phenol include bisphenol A and the like. These may be a modified product thereof, and can be used alone or in a combination of two or more kinds.

The alkylene oxide includes ethylene oxide, propylene oxide, and the like. These can be used alone or in a combination of two or more kinds.

The polymer-polyol includes dispersion of fine polymer particles such as fine poly(acrylonitrile) particles and fine polystyrene particles in the above polyoxyalkylene-based polyol.

The phenol resin-based polyol is a compound having two or more active hydrogen-containing groups determined according to the Zerewitinoff method in the molecule. Specific examples include novolak phenol resin-based polyols, resol phenol resin-based polyols, benzilic ether phenol resin-based polyols, and the like, obtainable by polycondensation reaction of a phenol and an aldehyde in the presence of a catalyst; modified phenol resin-based polyols obtainable by subjecting an alkylene oxide or an alkylene carbonate or the like to a ring-opening addition to a phenolic hydroxyl group in a part or all of the phenol resins, and the like.

The mannich-polyol includes those obtainable by condensation reaction of phenols, aldehydes, alkanolamines, and the like, and those obtainable by further optionally subjecting an alkylene oxide such as ethylene oxide or propylene oxide or the like to a ring-opening addition reaction.

In addition, since the number of functional groups in the above polyol (the number of hydroxyl groups in one molecule) differs depending upon the physical properties and the like of the desired rigid polyurethane foam, the number cannot be unconditionally determined, and the number of functional groups is usually from 2 to 8.

The amount of the component (A) in 100 parts by mass of the polyol mixture of the present invention is preferably 50 parts by mass or more, more preferably 55 parts by mass or more, and even more preferably 60 parts by mass or more, from the viewpoint of maintaining the physical properties as the rigid polyurethane foam. In addition, the amount is preferably 90 parts by mass or less, and more preferably 85 parts by mass or less, from the viewpoint of allowing the polyol mixture to foam and cure to adjust to an appropriate density. The amount of the component (A) as used herein means a total amount thereof in a case where the component (A) contains a plurality of polyols.

2. Component (B)

The blowing agent (B) in the present invention includes a hydrohaloolefin having a coefficient of ozone destruction of substantially zero, and a coefficient of global warming of 20 or less, from the viewpoint of global environmental protection, and TCTFP or CHFB is used, from the viewpoint of easiness in handling and the blowing properties of the polyurethane foam. These can be used alone or in a combination of two kinds. Here, TCTFP and CHFB as used herein may be collectively referred to as a “hydrohaloolefin-based blowing agent according to the present invention.” The hydrohaloolefin-based blowing agent according to the present invention is more preferably TCTFP, from the viewpoint of heat insulation property, availability, and economic advantages.

In addition, the blowing agent (B) in the present invention can contain other known blowing agent within the range that would not impair the objective of the present invention. As other blowing agents, water (in other words, carbon dioxide is generated in the reaction of water and isocyanate to become a blowing agent) can be used together, or a gas such as nitrogen, the air, or carbon dioxide; a low-boiling point aliphatic hydrocarbon such as normal butane, isobutane, normal pentane, neopentane, isopentane, cyclopentane, normal hexane, cyclohexane, methylcyclopentane, or methylcyclohexane; a hydrofluorocarbon such as 1,1,1,3,3-pentafluoropropane, or 1,1,1,3,3-pentafluorobutane may be used together. Also, a hydrofluoroolefin having a coefficient of global warming of 20 or less is preferred, for example, trans-1,3,3,3-tetrafluoro-1-propene, 2,3,3,3-tetrafluoro-1-propene, or the like may be used together.

When water is contained as the blowing agent (B), the amount of water based on 100 parts by mass of the component (A) is preferably 0.3 parts by mass or more, and more preferably 0.5 parts by mass or more, from the viewpoint of giving the rigid polyurethane foam strength physical properties, and the amount of water is 3 parts by mass or less, more preferably 2.5 parts by mass or less, and even more preferably 2.2 parts by mass or less, from the viewpoint of keeping excellent heat insulation property.

A total content of TCTFP and CHFB in the component (B) is preferably 85% by mass or more, and more preferably 92% by mass or more, from the viewpoint of blowing properties, workability, and heat insulation property of the polyurethane foam, and the total content is preferably 100% by mass or less, more preferably 98% by mass or less, and even more preferably 96% by mass or less, from the viewpoint of improving the physical properties of the polyurethane foam. The content of TCTFP in the component (B) is preferably 85% by mass or more, and more preferably 92% by mass or more, from the viewpoint of keeping excellent heat insulation property, and the content is preferably 100% by mass or less, more preferably 98% by mass or less, and even more preferably 96% by mass or less, from the viewpoint of improving the physical properties of the polyurethane foam.

Although the amount of the component (B) depends upon the density of the rigid polyurethane foam and the kinds of the hydrohaloolefin, the amount based on 100 parts by mass of the component (A) is preferably 7 parts by mass or more, more preferably 10 parts by mass or more, and even more preferably 15 parts by mass or more, from the viewpoint of reducing heat conductivity. Also, the amount based on 100 parts by mass of the component (A) is preferably 45 parts by mass or less, more preferably 40 parts by mass or less, and even more preferably 35 parts by mass or less, from the viewpoint of keeping the strength physical properties of the rigid polyurethane foam. Here, the amount of the component (B) as used herein means a total amount thereof in a case where the component (B) contains a plurality of blowing agents.

3. Component (C)

As the catalyst (C) in the present invention, an imidazole-based catalyst (C1) represented by the formula (I):

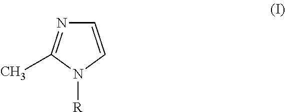

wherein R is a methyl group, an n-butyl group, or an isobutyl group, is used, from the viewpoint of reactivity of the polyol mixture and the inhibition of degradation for external appearance with the days passed (improvement in storage stability).

Concrete examples include 1,2-dimethylimidazole, 1-n-butyl-2-methylimidazole, and 1-isobutyl-2-methylimidazole, and 1-isobutyl-2-methylimidazole is preferred, from the viewpoint of mixing stability with the organic acid. These can be used alone or in a combination of two kinds.

In addition, the catalyst (C) in the present invention can contain other known catalysts within the range that would not impair the objective of the present invention. Other catalysts include tertiary amine-containing catalysts such as N,N,N′,N′-tetramethylethylenediamine, N,N,N′,N′-tetramethyl-1,3-propanediamine, N,N,N′,N′-tetramethyl-1,6-hexanediamine, tris(3-dimethylaminopropyl)amine, N,N-dimethylcyclohexylamine, N,N,N′-trimethylaminoethylpiperazine, N,N-dimethylpiperazine, N,N,N′,N″,N″-pentamethyldiethylenetriamine, bis(2-dimethylaminoethyl) ether, N,N′,N″-tris(3-dimethylaminopropyl)hexahydro-s-triazine, 1,8-diazabicyclo[5.4.0]undecene-7, N-methylmorpholine, N-ethylmorpholine, N-(dimethylaminoethyl)morpholine, dimorpholinodiethyl ether, N,N-dimethylbenzylamine, N-methyldicyclohexylamine, N-methyldiethanolamine, 1-methylimidazole, 3-aminopropylimidazole, 6-dimethylamino-1-hexanol, 5-dimethylamino-3-methyl-1-pentanol, bis(3-dimethylaminopropyl)amine, N,N-bis(3-dimethylaminopropyl)isopropanolamine, N-(3-dimethylaminopropyl)-N-methylethanolamine, N,N-dimethyl-N′,N′-bis(2-hydroxypropyl)-1,3-propanediamine, N,N-dimethylaminopropylamine, dimethylethanolamine, 2-(2-dimethylaminoethoxy)ethanol, 2-[2-(2-dimethylaminoethoxy)ethoxy]ethanol, N-(2-dimethylaminoethyl)-N-methylethanolamine, N-[2-(2-dimethylaminoethoxy)ethyl]-N-methylethanolamine, N,N,N′,N″-tetramethyl-N″-(2-hydroxypropyl)-diethylenetriamine and N-[2-(2-dimethylaminoethoxy)ethyl]-N-methyl-1,3-propanediamine; and derivatives of the tertiary amines mentioned above, and salts formed between the above tertiary amine and an acid such as a carboxylic acid or carbonic acid, and the like, and these can be used alone or in a combination of two or more kinds.

In addition, an organotin compound such as tin di(2-ethylhexanoate); an organometal catalyst such as bismuth tris(2-ethylhexanoate) and lead di(2-ethylhexanoate); a potassium salt such as potassium acetate or potassium octylate; or an isocyanurate catalyst such as a quaternary ammonium salt may be used, within the range that would not impair the objective of the present invention, which can be used alone or in combination of two or more kinds. Among these, when the rigid polyurethane foam is produced in a spray formulation, the organometal catalyst is preferably used together, from the viewpoint of improving reactivity by synergistic effects with the amine-based catalyst. When the rigid polyurethane foam is used in the application of heat insulation building materials, the isocyanurate catalyst is preferably used together, from the viewpoint of giving flame retardant property.

The content of the imidazole-based catalyst (C1) represented by the formula (I) in the component (C) is preferably 50% by mass or more, more preferably 60% by mass or more, and even more preferably 70% by mass or more, and the content is preferably 100% by mass or less. The content of the imidazole-based catalyst represented by the formula (I) as used herein means a total content thereof in a case where a plurality of the imidazole-based catalysts are contained.

Also, the amount of the imidazole-based catalyst (C1) represented by the formula (I), based on 100 parts by mass of the component (A) is preferably 1.2 parts by mass or more, more preferably 1.5 parts by mass or more, and even more preferably 1.8 parts by mass or more, from the viewpoint of securing fluidity of the rigid polyurethane foam, and giving excellent storage stability to the polyol mixture. In addition, the amount is preferably 5.5 parts by mass or less, more preferably 5.0 parts by mass or less, even more preferably 4.5 parts by mass or less, and still even more preferably 3.5 parts by mass or less.

A mass ratio of a total content of TCTFP (B1) and CHFB (B2) usable as the blowing agents of the present invention to the content of the imidazole-based catalyst (C1) represented by the formula (I), (B1+B2)/C1, is preferably 5 or more, more preferably 6 or more, even more preferably 6.5 or more, even more preferably 6.7 or more, even more preferably 7.5 or more, and even more preferably 8.0 or more, from the viewpoint of storage stability of the polyol mixture. In addition, the mass ratio is preferably 22 or less, more preferably 20 or less, even more preferably 18 or less, even more preferably 17.5 or less, and even more preferably 13 or less.

The amount of the component (C) may be appropriately determined according to the reactivities between the polyol component and the polyisocyanate component used, applications of the rigid polyurethane foam (specific production methods), and the like. Although the amount depends upon the kinds of catalysts, the amount based on 100 parts by mass of the component (A) is preferably 1.2 parts by mass or more, more preferably 1.5 parts by mass or more, and even more preferably 1.8 parts by mass or more, from the viewpoint of reactivities (blowing property and curing property) and giving the rigid polyurethane foam functions such as flame retardant property and adhesion. In addition, the amount is preferably 15 parts by mass or less, more preferably 10 parts by mass or less, and even more preferably 8 parts by mass or less. Here, the amount of the component (C) as used herein means a total amount thereof in a case where the component (C) contains a plurality of catalysts.

4. Component (D)

As the organic acid (D) in the present invention, succinic acid or glutaric acid is used, from the viewpoint of improving the reactivity at an initial stage, and reactivity and inhibition for external appearance from deterioration with the days passed (improvement in storage stability), and succinic acid is preferred, from the viewpoint of effectiveness in the improvement in reactivities. These may be used alone or in a combination of the two kinds.

In addition, the organic acid (D) in the present invention can contain, besides succinic acid and glutaric acid, a known organic acid as other organic acids, within the range that would not impair the objective of the present invention. Examples of other organic acids include monocarboxylic acids, dicarboxylic acids, phosphinic acid, phosphonic acid, sulfonic acid, sulfamic acid, and the like. Other organic acids include, for example, formic acid, acetic acid, propionic acid, butyric acid, caproic acid, isocaproic acid, 2-ethylhexanoic acid, caprylic acid, oleic acid, linoleic acid, linolenic acid, oxalic acid, malonic acid, adipic acid, sebacic acid, pimelic acid, suberic acid, azelaic acid, decanedicarboxylic acid, maleic acid, fumaric acid, benzoic acid, glycolic acid, and the like. These organic acids can be used alone or in a combination of two or more kinds.

A total content of the succinic acid and glutaric acid in the component (D) is preferably 50% by mass or more, more preferably 60% by mass or more, and even more preferably 70% by mass or more, and preferably 100% by mass or less.

A mass ratio of the total content of TCTFP (B1) and CHFB (B2) usable as blowing agents of the present invention to the total content of the organic acid (D) including succinic acid and glutaric acid, (B1+B2)/D, is preferably 10 or more, more preferably 13 or more, even more preferably 14 or more, and even more preferably 14.5 or more, from the viewpoint of solubility in the polyol mixture and storage stability. In addition, the mass ratio is preferably 40 or less, more preferably 35 or less, even more preferably 32 or less, and even more preferably 31 or less.

The amount of the component (D) based on 100 parts by mass of the component (A) is preferably 0.3 parts by mass or more, and more preferably 0.5 parts by mass or more, from the viewpoint of improving storage stability and reactivity of the polyol mixture. In addition, the amount is preferably 3 parts by mass or less, and more preferably 2 parts by mass or less, from the viewpoint of solubility in the polyol mixture and prevention of corrosion of a blowing machine or the like. Here, the amount of the component (D) as used herein means a total amount thereof in a case where the component (D) contains a plurality of organic acids.

5. Component (E)

The foam stabilizer (E) in the present invention includes those known in the art of the present invention, and the foam stabilizer includes, for example, silicone-based foam stabilizers such as polyoxyalkylene-poly(dimethyl siloxane) copolymers, poly(dialkyl siloxanes), polyoxyalkylene polyol-modified dimethyl polysiloxanes; and anionic surfactants such as salts of fatty acids, salts of sulfate esters, salts of phosphate esters, and sulfonates; and the like. These foam stabilizers may be used alone or in combination of two or more kinds. Among them, the silicone-based foam stabilizers are preferred, and the polyalkylene-poly(dimethyl siloxane) copolymer is more preferred, from the viewpoint of strong foam stabilizing strength and dimensional stability.

Although the amount of the component (E) may differ depending upon the kinds of the foam stabilizers, the amount based on 100 parts by mass of the component (A) is preferably 0.2 parts by mass or more, more preferably 0.5 parts by mass or more, and even more preferably 1.0 part by mass or more, from the viewpoint of securing foam stability of the cells and percentage of closed cell foam. In addition, the amount is preferably 4.0 parts by mass or less, more preferably 3.5 parts by mass or less, even more preferably 3.0 parts by mass or less, and still even more preferably 2.0 parts by mass or less.

6. Other Components

The polyol mixture may optionally contain other aids, in addition to the component (A) to the component (E). Other aids include aids that are generally used in the production of rigid polyurethane foams, including for example, crosslinking agents, flame retardants, pigments, fillers, and the like. These aids can be used within the range that would not impair the objective of the present invention, and the content thereof can also be properly adjusted in accordance with known techniques.

The crosslinking agent includes low molecular compounds having two or more groups selected from the group consisting of hydroxyl group, primary amino group, secondary amino group, and other active hydrogen-containing group, which is capable of reacting with an isocyanate group. Examples thereof include polyhydric alcohols such as ethylene glycol, diethylene glycol, propylene glycol, dipropylene glycol, 1,4-butanediol, 1,6-hexanediol, neopentyl glycol, glycerol, trimethylolpropane, triethanolamine, and alkylene oxide adducts of bisphenol A; polyamines such as diethyltoluenediamine, chlorodiaminobenzene, ethylenediamine, and 1,6-hexanediamine; and the like. These crosslinking agents can be used alone or in a combination of two or more kinds.

The flame retardants include halogen-containing flame retardants such as tricresyl phosphate, tris(2-chloroethyl) phosphate, tris(2-chloroisopropyl) phosphate, tris(1,3-dichloropropyl) phosphate, and tris(2,3-dibromopropyl) phosphate; and non-halogen-containing flame retardants such as triethyl phosphate. These flame retardants may be used alone or in a combination of two or more kinds. Among them, tris(2-chloroisopropyl) phosphate is preferred. The flame retardant can be used in an amount of preferably 10 parts by mass or more and 30 parts by mass or less, based on 100 parts by mass of the component (A), from the viewpoint of giving the rigid polyurethane foam flame retardant property without impairing its physical properties.

The pigment includes inorganic pigments represented by salts of transition metals; organic pigments represented by azo compounds; carbon powders; and the like. These pigments can be used alone or in a combination of two or more kinds.

The filler includes inorganic compounds such as fine silica-based particles and fine alumina-based particles; and organic compounds such as melamine-based resins and phenol resins.

The polyol mixture of the present invention can be easily prepared by mixing the component (A) to the component (E) mentioned above, and optionally other components. For example, in a case where an organic acid is a solid, the organic acid may be previously mixed with a catalyst and dissolved, and the solution may be mixed with other components.

Since the polyol mixture of the present invention has excellent storage stability even in the case where a hydrohaloolefin is used as a blowing agent, the state free from the lowering of reactivity or turbidity can be maintained over a long period of time, and the polyol mixture is also excellent in the reactivity at an initial stage. As a result, rapid and stable production can be realized during the production of the rigid polyurethane foam, so that the polyol mixture of the present invention can be more suitably used as raw materials for producing a rigid polyurethane foam.

<Method for Producing Rigid Polyurethane Foam>

The method for producing a rigid polyurethane foam of the present invention includes the step of mixing the above polyol mixture and a polyisocyanate component to allow blowing and curing reaction.

The polyisocyanate component includes those known in the art of the present invention, including, for example, aromatic polyisocyanates such as polymethylene polyphenylene polyisocyanate, tolylene diisocyanate, diphenylmethane diisocyanate, xylylene diisocyanate, and naphthylene diisocyanate; the modified products of the above polyisocyanates containing one or more of urethane bonds, carbodiimide bonds, uretonimine bonds, allophanate bonds, urea bonds, burette bonds, isocyanurate bonds, and the like. These polyisocyanate components may be used alone or in a combination of two or more kinds. Among the polyisocyanate component, the polymethylene polyphenylene polyisocyanate is preferred, from the viewpoint of giving strength to the rigid polyurethane foam and improving heat resistance.

The proportion of the polyol mixture and the polyisocyanate component is usually adjusted so that the isocyanate index is preferably 90 or more, more preferably 100 or more, and even more preferably 105 or more, and preferably 400 or less, more preferably 300 or less, and even more preferably 250 or less. In addition, the proportion is adjusted so that isocyanate index is preferably 90 or more and 400 or less, more preferably 100 or more and 300 or less, and even more preferably 105 or more and 250 or less.

The rigid polyurethane foam can be obtained by, for example, mixing a polyol mixture and a polyisocyanate component in a high-pressure blowing machine or the like while stirring, and thereafter injecting the mixture in a mold or spraying the mixture on a surface to be coated, to allow foaming and curing reaction. More specifically, the rigid polyurethane foam can be obtained by temperature-controlling a polyol mixture with a tank or the like to a temperature of 15° to 25° C., thereafter mixing the polyol mixture and a polyisocyanate component using a blowing machine such as a spray style blowing machine, an automatic mixing injection style blowing machine, or an automatic mixing injection style blowing machine, to allow foaming and curing reaction.

The polyol mixture of the present invention has excellent reactivity and storage stability; therefore, according to the method of the present invention, a stable rigid polyurethane foam can be produced rapidly by using the polyol mixture of the present invention. The rigid polyurethane foam obtained can be suitably used, for example, in insulation materials for building materials, refrigerators, refrigerating/freezing warehouses, bath tubs, and pipes; dew stoppers for houses, apartment houses, industrial pipes, and the like.

In the embodiments mentioned above, the present invention further discloses a polyol mixture, a method for producing a rigid polyurethane foam using the mixture, and a rigid polyurethane foam obtainable by the method listed below.

<1> A polyol mixture for producing a rigid polyurethane foam, the polyol mixture containing:

(A) a polyol component having a hydroxyl value of 100 mgKOH/g or more and 550 mgKOH/g or less;
(B) a blowing agent containing one or more hydrohaloolefin-based blowing agents selected from the group consisting of trans-1-chloro-3,3,3-trifluoro-1-propene (B1) and cis-1,1,1,4,4,4-hexafluoro-2-butene (B2);
(C) a catalyst containing an imidazole-based catalyst (C1) represented by the formula (I):

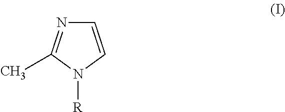

wherein R is a methyl group, an n-butyl group, or an isobutyl group;

(D) an organic acid containing one or more members selected from the group consisting of succinic acid and glutaric acid; and
(E) a foam stabilizer.

<2> The polyol mixture according to the above <1>, wherein the hydroxyl value (units: [mgKOH/g]) of the polyol component (A) is preferably 150 or more, and more preferably 200 or more, and preferably 500 or less, and more preferably 480 or less.

<3> The polyol mixture according to the above <1> or <2>, wherein the polyol component (A) preferably contains one or more polyols selected from the group consisting of polyester-polyols, polyether-polyols, polymer-polyols, phenol resin-based polyols, and mannich polyols.

<4> The polyol mixture according to the above <3>, wherein the polyester-polyol preferably is a phthalate-based polyester-polyol.

<5> The polyol mixture according to any one of the above <1> to <4>, wherein the amount of the component (A) based on 100 parts by mass of the polyol mixture is preferably 50 parts by mass or more, more preferably 55 parts by mass or more, and even more preferably 60 parts by mass or more, and preferably 90 parts by mass or less, and more preferably 85 parts by mass or less.

<6> The polyol mixture according to any one of the above <1> to <5>, wherein the blowing agent (B) is preferably TCTFP.

<7> The polyol mixture according to any one of the above <1> to <6>, wherein the blowing agent (B) preferably further contains water.

<8> The polyol mixture according to the above <7>, wherein the amount of water based on 100 parts by mass of the component (A) is preferably 0.3 parts by mass or more, and more preferably 0.5 parts by mass or more, and preferably 3 parts by mass or less, more preferably 2.5 parts by mass or less, and even more preferably 2.2 parts by mass or less.

<9> The polyol mixture according to any one of the above <1> to <8>, wherein a total content of TCTFP and CHFB in the component (B) is preferably 85% by mass or more, and more preferably 92% by mass or more, and preferably 100% by mass or less, more preferably 98% by mass or less, and even more preferably 96% by mass or less.

<10> The polyol mixture according to any one of the above <1> to <8>, wherein the content of TCTFP in the component (B) is preferably 85% by mass or more, and more preferably 92% by mass or more, and preferably 100% by mass or less, more preferably 98% by mass or less, and even more preferably 96% by mass or less.

<11> The polyol mixture according to any one of the above <1> to <10>, wherein the amount of the component (B) based on 100 parts by mass of the component (A) is preferably 7 parts by mass or more, more preferably 10 parts by mass or more, and even more preferably 15 parts by mass or more, and preferably 45 parts by mass or less, more preferably 40 parts by mass or less, and even more preferably 35 parts by mass or less.

<12> The polyol mixture according to any one of the above <1> to <11>, wherein the imidazole-based catalyst (C1) represented by the formula (I) is preferably one or more members selected from the group consisting of 1,2-dimethylimidazole, 1-n-butyl-2-methylimidazole, and 1-isobutyl-2-methylimidazole, and more preferably 1-isobutyl-2-methylimidazole.

<13> The polyol mixture according to any one of the above <1> to <12>, wherein the catalyst (C) preferably further contains one or more members selected from the group consisting of tertiary amine catalysts, derivatives thereof, and salts thereof.

<14> The polyol mixture according to any one of the above <1> to <13>, wherein the content of the imidazole-based catalyst (C1) represented by the formula (I) in the component (C) is preferably 50% by mass or more, more preferably 60% by mass or more, and even more preferably 70% by mass or more, and preferably 100% by mass or less.

<15> The polyol mixture according to any one of the above <1> to <14>, wherein the amount of the imidazole-based catalyst (C1) represented by the formula (I) based on 100 parts by mass of the component (A) is preferably 1.2 parts by mass or more, more preferably 1.5 parts by mass or more, and even more preferably 1.8 parts by mass or more, and preferably 5.5 parts by mass or less, more preferably 5.0 parts by mass or less, even more preferably 4.5 parts by mass or less, and still even more preferably 3.5 parts by mass or less.

<16> The polyol mixture according to any one of the above <1> to <15>, wherein the mass ratio of a total content of TCTFP (B1) and CHFB (B2) to the content of the imidazole-based catalyst (C1) represented by the formula (I), (B1+B2)/C1, is preferably 5 or more, more preferably 6 or more, even more preferably 6.5 or more, even more preferably 6.7 or more, even more preferably 7.5 or more, and even more preferably 8.0 or more, and preferably 22 or less, more preferably 20 or less, even more preferably 18 or less, even more preferably 17.5 or less, and even more preferably 13 or less.

<17> The polyol mixture according to any one of the above <1> to <16>, wherein the amount of the component (C) based on 100 parts by mass of the component (A) is preferably 1.2 parts by mass or more, more preferably 1.5 parts by mass or more, and even more preferably 1.8 parts by mass or more, and preferably 15 parts by mass or less, more preferably 10 parts by mass or less, and even more preferably 8 parts by mass or less.

<18> The polyol mixture according to any one of the above <1> to <17>, wherein the organic acid (D) is preferably succinic acid.

<19> The polyol mixture according to any one of the above <1> to <18>, wherein a total content of succinic acid and glutaric acid in the component (D) is preferably 50% by mass or more, more preferably 60% by mass or more, and even more preferably 70% by mass or more, and preferably 100% by mass or less.

<20> The polyol mixture according to any one of the above <1> to <19>, wherein the mass ratio of a total content of TCTFP (B1) and CHFB (B2) to a total content of the organic acid (D) including succinic acid and glutaric acid, (B1+B2)/D, is preferably 10 or more, more preferably 13 or more, even more preferably 14 or more, and even more preferably 14.5 or more, and preferably 40 or less, more preferably 35 or less, even more preferably 32 or less, and even more preferably 31 or less.

<21> The polyol mixture according to any one of the above <1> to <20>, wherein the amount of the component (D) based on 100 parts by mass of the component (A) is preferably 0.3 parts by mass or more, and more preferably 0.5 parts by mass or more, and preferably 3 parts by mass or less, and more preferably 2 parts by mass or less.

<22> The polyol mixture according to any one of the above <1> to <21>, wherein the foam stabilizer (E) is preferably one or more members selected from the group consisting of silicone-based foam stabilizers such as polyoxyalkylene-poly(dimethyl siloxane) copolymers, poly(dialkyl siloxanes), polyoxyalkylene polyol-modified dimethyl polysiloxanes; and anionic surfactants such as salts of fatty acids, salts of sulfate esters, salts of phosphate esters, and sulfonates, more preferably the silicone-based foam stabilizers, and even more preferably the polyalkylene-poly(dimethyl siloxane) copolymer.

<23> The polyol mixture according to any one of the above <1> to <22>, wherein the amount of the component (E) based on 100 parts by mass of the component (A) is preferably 0.2 parts by mass or more, more preferably 0.5 parts by mass or more, and even more preferably 1.0 part by mass or more, and preferably 4.0 parts by mass or less, more preferably 3.5 parts by mass or less, even more preferably 3.0 parts by mass or less, and even more preferably 2.0 parts by mass or less.

<24> The polyol mixture according to any one of the above <1> to <23>, further containing one or more members selected from the group consisting of crosslinking agents, flame retardants, pigments, and fillers.

<25> The polyol mixture according to the above <24>, wherein the amount of the flame retardant based on 100 parts by mass of the component (A) is preferably 10 parts by mass or more and 30 parts by mass or less.

<26> The polyol mixture according to any one of the above <1> to <25>, which is obtainable by mixing the component (A) to the component (E), and optionally other components.

<27> Use of a polyol mixture as defined in any one of the above <1> to <26>, in the manufacture of a rigid polyurethane foam.

<28> A method for producing a rigid polyurethane foam, including the step of mixing a polyol mixture as defined in any one of the above <1> to <26> and a polyisocyanate component, to allow foaming and curing reaction.

<29> The method according to the above <28>, wherein the polyisocyanate component is preferably one or more members selected from the group consisting of aromatic polyisocyanates such as polymethylene polyphenylene polyisocyanate, tolylene diisocyanate, diphenylmethane diisocyanate, xylylene diisocyanate, and naphthylene diisocyanate; the modified products of the above polyisocyanates containing one or more of urethane bonds, carbodiimide bonds, uretonimine bonds, allophanate bonds, urea bonds, burette bonds, isocyanurate bonds, and the like, and more preferably the polymethylene polyphenylene polyisocyanate.

<30> The method according to the above <28> or <29>, wherein the isocyanate index is preferably 90 or more, more preferably 100 or more, and even more preferably 105 or more, and preferably 400 or less, more preferably 300 or less, and even more preferably 250 or less.

<31> A rigid polyurethane foam, obtainable by the method as defined in the above <28> to <30>.

<32> Use of a rigid polyurethane foam as defined in the above <31> in insulation materials for building materials, refrigerators, refrigerating/freezing warehouses, bath tubs, pipes, and the like.

<33> Use of a rigid polyurethane foam as defined in the above <31> in dew stoppers for houses, apartment houses, industrial pipes, and the like.

### EXAMPLES

### Examples 1 to 16 and Comparative Examples 1 to 12

Polyols in compositional ratios listed in Tables 1 to 4 in a total amount of 100 parts by mass as a polyol component, 20 parts by mass of a flame retardant [tris(2-chloroisopropyl) phosphate, “TMCPP” manufactured by DAIHACHI CHEMICAL INDUSTRY CO., LTD.], and 1.5 parts by mass of a foam stabilizer [silicone-based foam stabilizer, “L-5340” manufactured by company formerly known as Nippon Unicar Co., Ltd.] were mixed at room temperature with a Labomixer, and the mixture was cooled to 15° C. On the other hand, a catalyst, an organic acid, and water in compositional ratios listed in Tables 1 to 4 were previously mixed to dissolve to prepare a catalyst-containing mixture. Here, the term “room temperature” as used herein refers to a temperature of from 18° to 25° C.

Next, with the mixture prepared above of the polyol component, the flame retardant, and the foam stabilizer were mixed the above catalyst-containing mixture (catalyst, organic acid, and water) and a hydrohaloolefin blowing agent [trans-1-chloro-3,3,3-trifluoro-1-propene, “Solstice LBA,” manufactured by Honeywell] in given amounts based on 100 parts by mass of the above polyol component at room temperature with a Labomixer, to provide a polyol mixture having compositions (parts by mass) listed in Tables 1 to 4. Here, a weighted average hydroxyl value of the polyol component having a compositional ratio shown in Example 1 was 465 mgKOH/g, and a weighted average hydroxyl value of the polyol component having a composition ratio shown in Example 15 was 464 mgKaOH/g.

Here, the raw materials used in each of Examples and each of Comparative are as follows.

### <Polyol>

TEROL 693: recycled PET-based polyester-polyol [hydroxyl value: 250 mgKOH/g, the number of hydroxyl groups: 2, “TEROL 693,” manufactured by OXID”]

455 AR: tolylenediamine-based polyether-polyol [hydroxyl value: 450 mgKOH/g, the number of hydroxyl groups: 4, “Exenol 455AR” manufactured by ASAHI GLASS CO., LTD.]

AE-300 ethylenediamine-based polyether-polyol [hydroxyl value: 768 mgKOH/g, the number of hydroxyl groups: 4, “ACTCOL AE-300” manufactured by Mitsui Chemicals & SKC Polyurethanes Inc.]

RDK-133: phthalate-based polyester-polyol [hydroxyl value: 315 mgKOH/g, the number of hydroxyl groups: 2, “MAXIMOL RDK-133” manufactured by KAWASAKI KASEI CHEMICALS LTD.]

S-1703: sucrose-based polyether-polyol [hydroxyl value: 380 mgKOH/g, the number of hydroxyl groups: 6, “Sumiphen 1703,” manufactured by Sumika Bayer Urethane Co., Ltd.]

### <Foam Stabilizer>

L-5340: silicone-based foam stabilizer [“L-5340,” manufactured by a company formerly known as Nippon Unicar Co., Ltd.]

### <Flame Retardant>

TCPP: [tris(2-chloroisopropyl) phosphate, “TMCPP,” manufactured by DAIHACHI CHEMICAL INDUSTRY CO., LTD.]

### <Blowing Agent>

Solstice LBA: trans-1-chloro-3,3,3-trifluoro-1-propene [“Solstice LBA,” manufactured by Honeywell; hereinafter also simply referred to as “LBA”]

### <Catalyst>

KL-120: 1-isobutyl-2-methylimidazole [“KAOLIZER No. 120,” manufactured by Kao Corporation]

1,2-DMI: 1,2-dimethylimidazole, reagent [manufactured by Tokyo Chemical Industry Co., Ltd.]

KL-P200: poly tertiary aminoglycol [“KAOLIZER P200,” manufactured by Kao Corporation]

KL-1: N,N,N′,N′-tetramethyl-1,6-hexadiamine [“KAOLIZER No. 1,” manufactured by Kao Corporation]

KL-3: N,N,N′,N″,N″-pentamethyldiethylenetriamine [“KAOLIZER No. 3,” manufactured by Kao Corporation]

### <Organic Acid>

Succinic Acid: reagent [manufactured by KISHIDA CHEMICAL Co., Ltd.]

Glutaric Acid: reagent [manufactured by Tokyo Chemical Industry Co., Ltd.]

Formic Acid: reagent [manufactured by Sigma-Aldrich, Japan]

Acetic Acid: reagent [manufactured by KISHIDA CHEMICAL Co., Ltd.]

2-EH Acid: 2-ethylhexanoic acid, reagent [manufactured by Wako Pure Chemical Industries, Ltd.]

Oxalic Acid: reagent [manufactured by KATAYAMA CHEMICAL INC.]

Malonic Acid: reagent [manufactured by Sigma-Aldrich, Japan]

Adipic Acid: reagent [manufactured by Asahi Kasei Chemicals Corp.]

Maleic Acid: reagent [manufactured by Wako Pure Chemical Industries, Ltd.]

Isocaproic Acid: reagent [manufactured by Tokyo Chemical Industry Co., Ltd.]

Next, the reactivity and the storage stability of the polyol mixtures obtained were evaluated in accordance with the following methods. The results are shown in Tables 1 to 4.

(1) Evaluation of External Appearance of Polyol Mixtures

One hundred grams of the polyol mixture obtained in Examples 1 to 16 and Comparative Examples 1 to 12 was poured into a 110 mL-transparent glass sample bottle, and the bottle was tightly sealed with a cap. The states (external appearance) of the polyol mixture after allowing the polyol mixture to stand for 3 hours after the preparation (initial stage) and after storage of allowing to stand at 25° C. for 3 weeks (after 3 weeks) were visually observed, and evaluated in accordance with the following evaluation criteria. The larger the numerical value of the evaluation criteria, it can be judged that the homogeneity of the polyol mixture is excellent. In addition, the smaller the difference in the numerical values between the initial stage and after 3 weeks, degradation of the external appearance and the homogeneity of the polyol mixture with days passed is inhibited, so that the polyol mixture has excellent storage stability.

[Evaluation Criteria]

6: no foreign substances being found in the polyol mixture;
5: the polyol mixture being slightly turbid, but no precipitates;
4: the polyol mixture being turbid in whiteness, but no precipitates;
3: very small amount of foggy precipitates being found in the polyol mixture;
2: precipitates being found in the polyol mixture; and
1: amine salts being precipitated out in crystal forms without being dissolved in the polyol mixture.

(2) Initial Reactivity and Reactivity with Passage of Time of the Polyol Mixtures

The polyol mixture obtained was mixed with an isocyanate component [NCO: 31.4%, “Sumidur 44V20,” manufactured by Sumika Bayer Urethane Co., Ltd.] while stirring at 15° C. with a Labomixer so as to have an isocyanate index of 110, and the reactivity of the mixture obtained was evaluated by the following method. As the polyol mixture, initial stage products immediately after the preparation and days-passed products stored by allowing to stand at 25° C. for 3 weeks were used.

[Reactivity]

Time periods (seconds) for reaching CT (cream time) and GT (gel time) when subjecting 40 g of the above mixture stirred in a 300 mL polypropylene cup [“Descup (PP Disposable Beaker)” manufactured by TERAOKA] to free foaming were measured. Those having a smaller ratio of CT to GT (CT/GT value) can be judged to have high reactivity against the foaming reaction at an initial stage.

TABLE 1

| | | Examples | | | | | | | |
|---|---|---|---|---|---|---|---|---|---|
| | | 1 | 2 | 3 | 4 | 5 | 6 | 7 | 8 |
| Polyol Mixture | | | | | | | | | |
| (Parts by Mass) | | | | | | | | | |
| (A) Polyol | TEROL 693 | 40 | 40 | 40 | 40 | 40 | 40 | 40 | 40 |
| | 455AR | 30 | 30 | 30 | 30 | 30 | 30 | 30 | 30 |
| | AE-300 | 30 | 30 | 30 | 30 | 30 | 30 | 30 | 30 |
| Flame | TCPP | 20 | 20 | 20 | 20 | 20 | 20 | 20 | 20 |
| Retardant | | | | | | | | | |
| (E) Foam | L-5340 | 1.5 | 1.5 | 1.5 | 1.5 | 1.5 | 1.5 | 1.5 | 1.5 |
| Stabilizer | | | | | | | | | |
| (C) Catalyst | KL-120 | 3.0 | 3.0 | — | 3.0 | 2.0 | 3.0 | 3.0 | 2.0 |
| | 1,2-DMI | — | — | 2.1 | — | — | — | — | — |
| (D) Organic | Succinic Acid | 1.28 | 0.85 | 0.86 | 1.71 | 0.85 | 1.28 | — | 1.14 |
| Acid | Glutaric Acid | — | — | — | — | — | — | 1.43 | — |
| (B) Blowing | Solstice LBA | 25 | 25 | 25 | 25 | 25 | 20 | 25 | 35 |
| Agent | Water | 2.0 | 2.0 | 2.0 | 2.0 | 2.0 | 2.0 | 2.0 | 2.0 |
| Mass Ratio of LBA/ | | 8.3 | 8.3 | 11.9 | 8.3 | 12.5 | 6.7 | 8.3 | 17.5 |
| Imidazole- | | | | | | | | | |
| Based Catalyst | | | | | | | | | |
| Mass Ratio of LBA/Organic | | 19.5 | 29.4 | 29.1 | 14.6 | 29.4 | 15.6 | 17.5 | 30.7 |
| Acid | | | | | | | | | |
| Polyisocyanate Component | | Isocyanate Index 110 | | | | | | | |
| (Sumidur 44V20) | | | | | | | | | |
| Evaluation | | | | | | | | | |
| | Reactivity | | | | | | | | |
| Initial Stage | CT (sec) | 7.5 | 8.6 | 8.2 | 6.9 | 9.6 | 7.9 | 8.2 | 8.5 |
| | GT (sec) | 32.8 | 33.3 | 33.5 | 32.2 | 37.8 | 32.5 | 33.4 | 37.3 |
| | CT/GT | 0.229 | 0.258 | 0.245 | 0.214 | 0.254 | 0.243 | 0.246 | 0.228 |
| | External | 6 | 6 | 6 | 6 | 6 | 6 | 6 | 6 |
| | Appearance | | | | | | | | |
| | Reactivity | | | | | | | | |
| After | CT (sec) | 7.5 | 8.7 | 8.4 | 6.8 | 9.8 | 7.9 | 8.4 | 8.5 |
| 3 Weeks | GT (sec) | 33.1 | 33.5 | 33.6 | 32.3 | 38.1 | 32.7 | 33.6 | 37.6 |
| | CT/GT | 0.227 | 0.260 | 0.250 | 0.211 | 0.257 | 0.242 | 0.250 | 0.226 |
| | External | 6 | 6 | 6 | 6 | 6 | 6 | 6 | 6 |
| | Appearance | | | | | | | | |

TABLE 2

| | | Examples | | | | | |
|---|---|---|---|---|---|---|---|
| | | 9 | 10 | 11 | 12 | 13 | 14 |
| Polyol Mixture | | | | | | | |
| (Parts by Mass) | | | | | | | |
| (A) Polyol | TEROL 693 | 40 | 40 | 40 | 40 | 40 | 40 |
| | 455AR | 30 | 30 | 30 | 30 | 30 | 30 |
| | AE-300 | 30 | 30 | 30 | 30 | 30 | 30 |
| Flame | TCPP | 20 | 20 | 20 | 20 | 20 | 20 |
| Retardant | | | | | | | |
| (E) Foam | L-5340 | 1.5 | 1.5 | 1.5 | 1.5 | 1.5 | 1.5 |
| Stabilizer | | | | | | | |
| (C) Catalyst | KL-120 | 4.2 | — | — | 1.5 | 3.0 | 3.0 |
| | 1,2-DMI | — | 1.8 | 1.8 | — | — | — |
| | KL P200 | — | — | — | 1.5 | — | — |
| (D) Organic | Succinic Acid | 1.28 | — | 1.47 | 1.28 | 1.92 | 0.72 |
| Acid | Glutaric Acid | — | 1.64 | — | — | — | — |
| (B) Blowing | Solstice LBA | 25 | 35 | 35 | 30 | 25 | 25 |
| Agent | Water | 2.0 | 2.0 | 2.0 | 2.0 | 2.0 | 2.0 |
| Mass Ratio of LBA/ | | 6.0 | 19.6 | 19.6 | 20.0 | 8.3 | 8.3 |
| Imidazole- | | | | | | | |
| Based Catalyst | | | | | | | |
| Mass Ratio of LBA/Organic | | 19.5 | 21.3 | 23.8 | 23.4 | 13.0 | 34.7 |
| Acid | | | | | | | |
| Polyisocyanate Component | | Isocyanate Index 110 | | | | | |
| (Sumidur 44V20) | | | | | | | |
| Evaluation | | | | | | | |
| | Reactivity | | | | | | |
| Initial Stage | CT (sec) | 5.8 | 6.5 | 6.1 | 6.2 | 4.5 | 8.8 |
| | GT (sec) | 27.1 | 36.2 | 35.8 | 37.3 | 31.5 | 33.4 |
| | CT/GT | 0.214 | 0.180 | 0.170 | 0.166 | 0.143 | 0.263 |
| | External | 6 | 5 | 4 | 5 | 4 | 6 |
| | Appearance | | | | | | |
| | Reactivity | | | | | | |
| After | CT (sec) | 5.9 | 6.6 | 6.2 | 6.4 | 4.6 | 8.8 |
| 3 Weeks | GT (sec) | 27.0 | 36.6 | 36.1 | 37.6 | 31.8 | 33.6 |
| | CT/GT | 0.219 | 0.180 | 0.172 | 0.170 | 0.145 | 0.262 |
| | External | 6 | 5 | 4 | 5 | 4 | 6 |
| | Appearance | | | | | | |

TABLE 3

| | | Examples | | | Comparative Examples | | | | |
|---|---|---|---|---|---|---|---|---|---|
| | | 1 | 15 | 16 | 1 | 2 | 3 | 4 | 5 |
| Polyol Mixture | | | | | | | | | |
| (Parts by Mass) | | | | | | | | | |
| (A) Polyol | TEROL 693 | 40 | — | 40 | 40 | 40 | 40 | 40 | 40 |
| | RDK-133 | — | 50 | — | — | — | — | — | — |
| | 455AR | 30 | — | 30 | 30 | 30 | 30 | 30 | 30 |
| | AE-300 | 30 | 30 | 30 | 30 | 30 | 30 | 30 | 30 |
| | S-1703 | — | 20 | — | — | — | — | — | — |
| Flame | TCPP | 20 | 20 | 20 | 20 | 20 | 20 | 20 | 20 |
| Retardant | | | | | | | | | |
| (E) Foam | L-5340 | 1.5 | 1.5 | 1.5 | 1.5 | 1.5 | 1.5 | 1.5 | 1.5 |
| Stabilizer | | | | | | | | | |
| (C) Catalyst | KL-120 | 3.0 | 3.0 | 3.0 | 3.0 | — | — | — | — |
| | KL-1 | — | — | — | — | 1.5 | — | 1.5 | — |
| | KL-3 | — | — | — | — | — | 1.0 | — | 1.0 |
| (D) Organic | Succinic Acid | 1.28 | 1.28 | 0.85 | — | — | — | 1.03 | — |
| Acid | Maleic Acid | — | — | 0.42 | — | — | — | — | — |
| | Isocaproic Acid | — | — | — | — | — | — | — | 2.01 |
| (B) Blowing | Solstice LBA | 25 | 25 | 25 | 25 | 25 | 25 | 25 | 25 |
| Agent | Water | 2.0 | 2.0 | 2.0 | 2.0 | 2.0 | 2.0 | 2.0 | 2.0 |
| Mass Ratio of LBA/ | | 8.3 | 8.3 | 8.3 | 8.3 | — | — | — | — |
| Imidazole- | | | | | | | | | |
| Based Catalyst | | | | | | | | | |
| Mass Ratio of LBA/Organic | | 19.5 | 19.5 | 19.7 | — | — | — | 24.3 | 12.4 |
| Acid | | | | | | | | | |
| Polyisocyanate | | Isocyanate Index 110 | | | | | | | |
| Component | | | | | | | | | |
| (Sumidur 44V20) | | | | | | | | | |
| Evaluation | | | | | | | | | |
| | Reactivity | | | | | | | | |
| Initial Stage | CT (sec) | 7.5 | 8.0 | 8.5 | 11.4 | 9.5 | 6.3 | 7.6 | 8.4 |
| | GT (sec) | 32.8 | 32.2 | 34.2 | 34.3 | 36.2 | 32.5 | 33.9 | 39.5 |
| | CT/GT | 0.229 | 0.248 | 0.249 | 0.332 | 0.262 | 0.194 | 0.224 | 0.213 |
| | External | 6 | 6 | 6 | 6 | 6 | 6 | 6 | 6 |
| | Appearance | | | | | | | | |
| | Reactivity | | | | | | | | |
| After | CT (sec) | 7.5 | 8.0 | 8.6 | 11.6 | 12.9 | 8.9 | 8.6 | 9.4 |
| 3 Weeks | GT (sec) | 33.1 | 32.4 | 34.3 | 34.8 | 39.8 | 39.3 | 38.9 | 43.4 |
| | CT/GT | 0.227 | 0.247 | 0.251 | 0.333 | 0.324 | 0.226 | 0.221 | 0.217 |
| | External | 6 | 6 | 6 | 2 | 2 | 2 | 2 | 2 |
| | Appearance | | | | | | | | |

TABLE 4

| | | | Comparative Examples | | | | | | |
|---|---|---|---|---|---|---|---|---|---|
| | | Example 1 | 6 | 7 | 8 | 9 | 10 | 11 | 12 |
| Polyol Mixture | | | | | | | | | |
| (Parts by Mass) | | | | | | | | | |
| (A) Polyol | TEROL 693 | 40 | 40 | 40 | 40 | 40 | 40 | 40 | 40 |
| | 455AR | 30 | 30 | 30 | 30 | 30 | 30 | 30 | 30 |
| | AE-300 | 30 | 30 | 30 | 30 | 30 | 30 | 30 | 30 |
| Flame | TCPP | 20 | 20 | 20 | 20 | 20 | 20 | 20 | 20 |
| Retardant | | | | | | | | | |
| (E) Foam | L-5340 | 1.5 | 1.5 | 1.5 | 1.5 | 1.5 | 1.5 | 1.5 | 1.5 |
| Stabilizer | | | | | | | | | |
| (C) Catalyst | KL-120 | 3.0 | 3.0 | 3.0 | 3.0 | 3.0 | 3.0 | 3.0 | 3.0 |
| (D) Organic | Succinic Acid | 1.28 | — | — | — | — | — | — | — |
| Acid | Formic Acid | — | 1.00 | — | — | — | — | — | — |
| | Acetic Acid | — | — | 1.30 | — | — | — | — | — |
| | 2-EH Acid | — | — | — | 3.13 | — | — | — | — |
| | Oxalic Acid | — | — | — | — | 0.98 | — | — | — |
| | Malonic Acid | — | — | — | — | — | 1.13 | — | — |
| | Adipic Acid | — | — | — | — | — | — | 1.59 | — |
| | Maleic Acid | — | — | — | — | — | — | — | 1.26 |
| (B) | Solstice LBA | 25 | 25 | 25 | 25 | 25 | 25 | 25 | 25 |
| Blowing | Water | 2.0 | 2.0 | 2.0 | 2.0 | 2.0 | 2.0 | 2.0 | 2.0 |
| Agent | | | | | | | | | |
| Mass Ratio of LBA/ | | 8.3 | 8.3 | 8.3 | 8.3 | 8.3 | 8.3 | 8.3 | 8.3 |
| Imidazole- | | | | | | | | | |
| Based Catalyst | | | | | | | | | |
| Mass Ratio of LBA/Organic | | 19.5 | 25.0 | 19.2 | 8.0 | 25.5 | 22.1 | 15.7 | 19.8 |
| Acid | | | | | | | | | |
| Polyisocyanate | | Isocyanate Index 110 | | | | | | | |
| Component | | | | | | | | | |
| (Sumidur 44V20) | | | | | | | | | |
| Evaluation | | | | | | | | | |
| | Reactivity | | | | | | | | |
| Initial Stage | CT (sec) | 7.5 | 12.1 | 12.5 | 12.6 | 18.2 | 12.7 | 12.4 | 10.7 |
| | GT (sec) | 32.8 | 37.2 | 37.3 | 37.7 | 68.0 | 37.6 | 37.9 | 37.1 |
| | CT/GT | 0.229 | 0.325 | 0.335 | 0.334 | 0.268 | 0.338 | 0.327 | 0.288 |
| | External | 6 | 6 | 6 | 6 | 1 | 6 | 6 | 6 |
| | Appearance | | | | | | | | |
| | Reactivity | | | | | | | | |
| After 3 | CT (sec) | 7.5 | 12.4 | 12.6 | 12.8 | 18.5 | 12.7 | 12.5 | 11.0 |
| Weeks | GT (sec) | 33.1 | 37.5 | 37.4 | 37.9 | 69.5 | 37.9 | 38.2 | 37.5 |
| | CT/GT | 0.227 | 0.331 | 0.337 | 0.338 | 0.266 | 0.335 | 0.327 | 0.293 |
| | External | 6 | 5 | 6 | 6 | 1 | 6 | 6 | 6 |
| | Appearance | | | | | | | | |

As a result, it is clear that the polyol mixture of the present invention has excellent storage stability and high reactivity. Especially, it can be seen from the matters that in the cases where the hydrohaloolefin and the imidazole-based catalyst are of the same level, Examples 1 and 7 where succinic acid or glutaric acid is contained in an equivalent amount based on the imidazole-based catalyst have higher reactivity as compared to Comparative Example 1 not containing an organic acid, and that Comparative Examples 6 to 12 containing other organic acids in an equivalent amount based on the imidazole-based catalyst have lower reactivities than Example 1, so that the effects peculiar to succinic acid or glutaric acid are exhibited. Also, it can be seen from Comparative Examples 1 to 3 that when an organic acid is not contained, the reactivity may be likely to be lowered or precipitates are likely to be formed due to degradation of the polyol mixture with the passage of time. In addition, even in a case of Comparative Example 4 where an amine-based catalyst other than the imidazole-based catalyst is used together with succinic acid, although the reactivity is more improved than Comparative Example 2, the storage stability is worsened.

### INDUSTRIAL APPLICABILITY

The polyurethane foam obtained by using a polyol mixture of the present invention can be suitably used as insulation materials for building materials, refrigerators, refrigerating/freezing warehouses, bath tubs, pipes, and the like; dew stoppers for houses, apartment houses, industrial pipes, and the like. In addition, the method of the present invention can be suitably used when producing heat insulation materials, dew stoppers, and the like by spray foaming compositions at building sites requiring especially high reactivity.

1. A polyol mixture for producing a rigid polyurethane foam, the polyol mixture comprising:
(A) a polyol component having a hydroxyl value of 100 mgKOH/g or more and 550 mgKOH/g or less;
(B) a blowing agent comprising one or more hydrohaloolefin-based blowing agents selected from the group consisting of trans-1-chloro-3,3,3-trifluoro-1-propene (B1) and cis-1,1,1,4,4,4-hexafluoro-2-butene (B2);
(C) a catalyst comprising an imidazole-based catalyst (C1) represented by the formula (I): 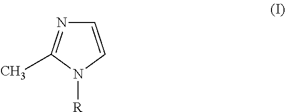
wherein R is a methyl group, an n-butyl group, or an isobutyl group;
(D) an organic acid comprising one or more members selected from the group consisting of succinic acid and glutaric acid; and
(E) a foam stabilizer.

2. The polyol mixture according to claim 1, wherein the hydroxyl value (units: [mgKOH/g]) of the polyol component (A) is 150 or more and 500 or less.

3. The polyol mixture according to claim 1, wherein the polyol component (A) comprises one or more polyols selected from the group consisting of polyester-polyols, polyether-polyols, polymer-polyols, phenolic resin-based polyols, and mannich polyols.

4. The polyol mixture according to claim 1, wherein the amount of the component (A) is 50 parts by mass or more and 90 parts by mass or less, based on 100 parts by mass of the polyol mixture.

5. The polyol mixture according to claim 1, wherein a total content of trans-1-chloro-3,3,3-trifluoro-1-propene (B1) and cis-1,1,1,4,4,4-hexafluoro-2-butene (B2) in the component (B) is 85% by mass or more and 100% by mass or less.

6. The polyol mixture according to claim 1, wherein the blowing agent (B) is in an amount of from 7 parts by mass or more and 45 parts by mass or less, based on 100 parts by mass of the polyol component (A).

7. The polyol mixture according to claim 1, wherein the imidazole-based catalyst (C1) represented by the formula (I) is one or more members selected from the group consisting of 1,2-dimethylimidazole, 1-n-butyl-2-methylimidazole, and 1-isobutyl-2-methylimidazole.

8. The polyol mixture according to claim 1, wherein the catalyst (C) further comprises one or more members selected from the group consisting of tertiary amine catalysts, derivatives thereof, and salts thereof.

9. The polyol mixture according to claim 1, wherein the content of the imidazole-based catalyst (C1) represented by the formula (I) in the component (C) is 50% by mass or more and 100% by mass or less.

10. The polyol mixture according to claim 1, wherein the imidazole-based catalyst (C1) represented by the formula (I) is 1.2 parts by mass or more and 5.5 parts by mass or less, based on 100 parts by mass of the polyol component (A).

11. The polyol mixture according to claim 1, wherein a mass ratio of a total content of trans-1-chloro-3,3,3-trifluoro-1-propene (B1) and cis-1,1,1,4,4,4-hexafluoro-2-butene (B2) to the content of the imidazole-based catalyst (C1) represented by the formula (I), (B1+B2)/C1, is 5 or more and 22 or less.

12. The polyol mixture according to claim 1, wherein a mass ratio of a total content of trans-1-chloro-3,3,3-trifluoro-1-propene (B1) and cis-1,1,1,4,4,4-hexafluoro-2-butene (B2) to the content of the imidazole-based catalyst (C1) represented by the formula (I), (B1+B2)/C1, is 6.5 or more and 18 or less.

13. The polyol mixture according to claim 1, wherein the amount of the component (C) is 1.2 parts by mass or more and 15 parts by mass or less, based on 100 parts by mass of the component (A).

14. The polyol mixture according to claim 1, wherein a mass ratio of a total content of trans-1-chloro-3,3,3-trifluoro-1-propene (B1) and cis-1,1,1,4,4,4-hexafluoro-2-butene (B2) to the content of the organic acid (D), (B1+B2)/D, is 10 or more and 40 or less.

15. The polyol mixture according to claim 1, wherein a mass ratio of a total content of trans-1-chloro-3,3,3-trifluoro-1-propene (B1) and cis-1,1,1,4,4,4-hexafluoro-2-butene (B2) to the content of the organic acid (D), (B1+B2)/D, is 14 or more and 32 or less.

16. The polyol mixture according to claim 1, wherein the amount of the component (D) is 0.3 parts by mass or more and 3 parts by mass or less, based on 100 parts by mass of the component (A).

17. The polyol mixture according to claim 1, wherein the foam stabilizer (E) is one or more members selected from the group consisting of silicone-based foam stabilizers and anionic surfactants.

18. A method for producing a rigid polyurethane foam comprising the steps of mixing a polyol mixture as defined in claim 1 and a polyisocyanate component, to allow foaming and curing reaction.

19. The method according to claim 18, wherein the polyisocyanate component is one or more members selected from the group consisting of aromatic polyisocyanates such as polymethylene polyphenylene polyisocyanate, tolylene diisocyanate, diphenylmethane diisocyanate, xylylene diisocyanate, and naphthylene diisocyanate; the modified products of the polyisocyanates comprising one or more of urethane bonds, carbodiimide bonds, uretonimine bonds, allophanate bonds, urea bonds, burette bonds, isocyanurate bonds, and the like.

20. The method according to claim 18, wherein the isocyanate index is 90 or more and 400 or less.
